(19) United States
(12) Patent Application Publication
(10) Pub. No.: US 2026/0229414 A1
(43) Pub. Date: Aug. 6, 2026

(54) MULTILAYER CERAMIC CAPACITOR

(71) Applicant: Murata Manufacturing Co., Ltd., Nagaokakyo-shi (JP)

(72) Inventors: Ryuki KAKUTA, Nagaokakyo-shi (JP); Tsuyoshi YAMAMOTO, Nagaokakyo-shi (JP)

(73) Assignee: Murata Manufacturing Co., Ltd., Nagaokakyo-shi (JP)

(21) Appl. No.: 19/439,483

(22) Filed: Jan. 5, 2026

(30) Foreign Application Priority Data
Feb. 4, 2025 (JP) 2025-016882

(51) Int. Cl. H01G 4/30; H01G 4/005; H01G 4/12; H01G 4/232; H01G 4/248

(52) U.S. Cl. CPC H01G 4/30; H01G 4/005; H01G 4/232; H01G 4/248; H01G 4/12

(57) ABSTRACT

A multilayer ceramic capacitor includes a multilayer body having a plurality of dielectric layers and a plurality of inner electrode layers that are laminated together along a lamination direction. The multilayer ceramic capacitor include an outer electrode electrically connected to at least one of the plurality of inner electrode layers. The multilayer body includes an uneven interface between a first layer selected from the plurality of dielectric layers and a second layer selected from the plurality of inner electrode layers. The uneven interface includes a plurality of recessed portions defined in the first layer, and the second layer includes a plurality of protruding portions extending into the plurality of recessed portions.

### CROSS-REFERENCE TO RELATED APPLICATION

This application claims the benefit of priority to Japanese Patent Application No. 2025-016882, filed on Feb. 4, 2025, the entire contents of which are incorporated herein by reference.

### BACKGROUND

### 1. Field

The present disclosure relates to a multilayer ceramic capacitor.

### 2. Description of the Related Art

Japanese Unexamined Patent Application Publication No. 2021-40120 describes an example of a multilayer ceramic capacitor including a multilayer body formed by a plurality of dielectric layers and a plurality of inner electrode layers being laminated together. In manufacturing the multilayer body, inner electrode layers are printed as necessary on the surface of ceramic green sheets that become dielectric layers. The ceramic green sheets subjected to these processes are laminated together to form the multilayer body. The multilayer body is sintered by being heated.

### SUMMARY

A multilayer ceramic capacitor includes: a multilayer body including a plurality of dielectric layers and a plurality of inner electrode layers that are laminated together in a lamination direction. An outer electrode is electrically connected to at least one of the plurality of inner electrode layers. The multilayer body includes an uneven interface between a first layer selected from the plurality of dielectric layers and a second layer selected from the plurality of inner electrode layers. The uneven interface includes a plurality of recessed portions defined in the first layer, and the second layer includes a plurality of protruding portions extending into the plurality of recessed portions.

### BRIEF DESCRIPTION OF THE DRAWINGS

FIG. 1 is a perspective view of a multilayer ceramic capacitor according to a first embodiment;

FIG. 2 is a perspective view of a body portion included in the multilayer ceramic capacitor according to the first embodiment;

FIG. 3 is a cross-sectional view as viewed along arrows III-III in FIG. 1;

FIG. 4 is a cross-sectional view as viewed along arrows IV-IV in FIG. 1;

FIG. 5 is a plan view illustrating the overlap between inner electrode layers and dielectric layers included in the multilayer ceramic capacitor according to the first embodiment;

FIG. 6 is a cross-sectional view as viewed along arrows VI-VI in FIG. 5;

FIG. 7 is a plan view illustrating the overlap between the inner electrode layers and the dielectric layers included in a modification of the multilayer ceramic capacitor according to the first embodiment; and

FIG. 8 is a cross-sectional view as viewed along arrows VIII-VIII in FIG. 7.

### DESCRIPTION OF THE EMBODIMENTS

In the related art discussed above, since the inner electrode layers are made of metal and the dielectric layers are made of ceramic, the thermal shrinkage rates thereof differ from each other. There is a problem in that delamination occurs in the multilayer body due to the difference in thermal shrinkage between the inner electrode layers and the dielectric layers when the multilayer body is sintered by being heated.

Accordingly, the present disclosure is directed to providing a multilayer ceramic capacitor that can suppress the occurrence of possible delamination between the inner electrode layers and the dielectric layers in the multilayer body during sintering.

According to the present disclosure, since at least portions of the plurality of dielectric layers fit into the plurality of grooves, or vice versa, the joint between the dielectric layers and the inner electrode layers becomes strong, and accordingly, possible delamination between the inner electrode layers and the dielectric layers in the multilayer body during sintering may be reduced.

The dimensional ratios illustrated in the drawings do not necessarily represent actual ones accurately and may be exaggerated for the convenience of description. In the following description, references to upper or lower concept do not necessarily mean absolute upper or lower concept and may mean relative upper or lower concept in the illustrated posture.

### FIRST EMBODIMENT

### Structure

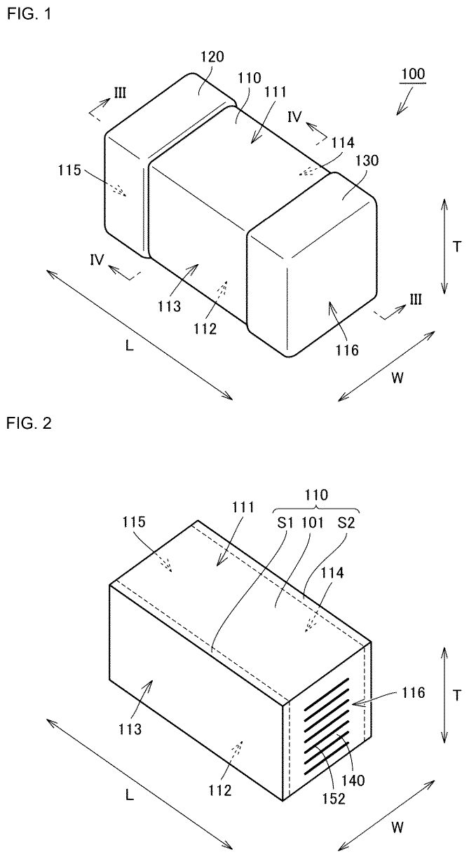

A multilayer ceramic capacitor according to a first embodiment will be described with reference to FIGS. 1 to 6.

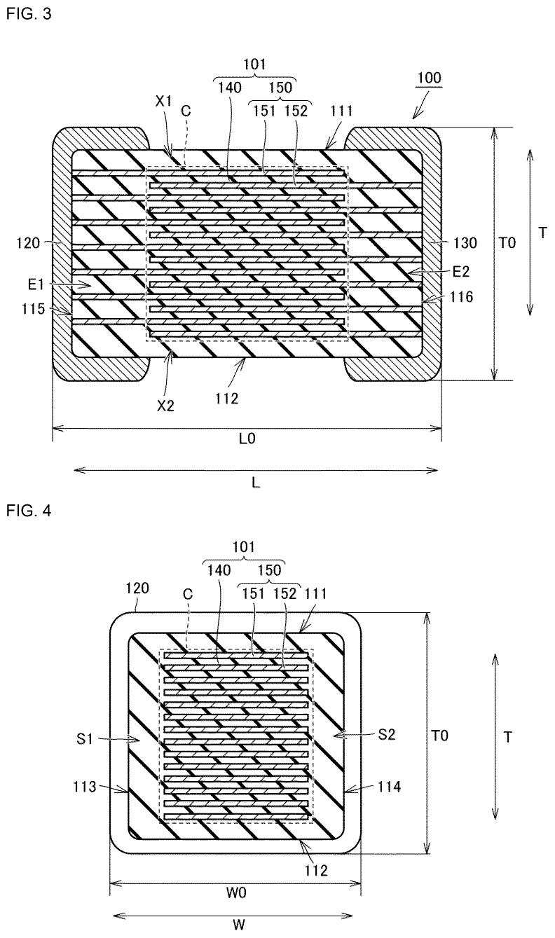

The appearance of a multilayer ceramic capacitor 100 according to the embodiment will be illustrated in FIG. 1. A body portion 110, which is a portion of the multilayer ceramic capacitor 100, is illustrated in FIG. 2. A cross-sectional view as viewed along arrows III-III in FIG. 1 is illustrated in FIG. 3. A cross-sectional view as viewed along arrows IV-IV in FIG. 1 is illustrated in FIG. 4.

As illustrated in FIG. 1, the multilayer ceramic capacitor 100 includes the body portion 110 and outer electrodes disposed on the body portion 110. The multilayer ceramic capacitor 100 includes a first outer electrode 120 and a second outer electrode 130 as the outer electrodes.

As illustrated in FIG. 1, the body portion 110 has a substantially rectangular parallelepiped shape. As illustrated in FIGS. 1 and 2, the body portion 110 has a first main surface 111 and a second main surface 112 that face away from each other in a thickness direction T, a first side surface 113 and a second side surface 114 that face away from each other in a width direction W that intersects the thickness direction T, and a first end face 115 and a second end face 116 that face away from each other in a length direction L that intersects the thickness direction T and the width direction W.

The corner portions and the ridge portions of the body portion 110 may be rounded. Here, three surfaces of the body portion 110 intersect at each of the corner portions, and two surfaces of the body portion 110 intersect at each of the ridge portions.

As illustrated in FIGS. 1 and 3, the first outer electrode 120 is provided on the first end face 115. Specifically, the first outer electrode 120 is formed over the entire first end face 115 and is formed to wrap around from the first end face 115 to the first main surface 111, the second main surface 112, the first side surface 113, and the second side surface 114.

As illustrated in FIGS. 1 and 3, the second outer electrode 130 is provided on the second end face 116. Specifically, the second outer electrode 130 is formed over the entire second end face 116 and is formed to wrap around from the second end face 116 to the first main surface 111, the second main surface 112, the first side surface 113, and the second side surface 114.

As illustrated in FIG. 2, the body portion 110 includes a multilayer body 101, a first side margin portion S1, and a second side margin portion S2.

As illustrated in FIGS. 3 and 4, the multilayer body 101 includes a plurality of dielectric layers 140 and a plurality of inner electrode layers 150 that are alternately laminated together in the thickness direction T. The plurality of inner electrode layers 150 include a plurality of first inner electrode layers 151 and a plurality of second inner electrode layers 152. The plurality of first inner electrode layers 151 and the plurality of second inner electrode layers 152 are alternately laminated together in the thickness direction T.

The plurality of first inner electrode layers 151 are extended to the first end face 115. The plurality of first inner electrode layers 151 are connected to the first outer electrode 120. The plurality of second inner electrode layers 152 are extended to the second end face 116. The plurality of second inner electrode layers 152 are connected to the second outer electrode 130.

It should be noted that FIGS. 3 and 4 illustrate an example in which sevens first inner electrode layers 151 and seven second inner electrode layers 152 are provided, but the number of the first inner electrode layers 151 and the number of the second inner electrode layers 152 are not limited to seven.

The plurality of dielectric layers 140 include outer dielectric layers located between the inner electrode layer 150 closest to the first main surface 111 in the thickness direction T and the first main surface 111 and located between the inner electrode layer 150 closest to the second main surface 112 in the thickness direction T and the second main surface 112 and inner dielectric layers located between adjacent inner electrode layers 150 in the thickness direction T.

The number of the plurality of dielectric layers 140 may be 100 or more and 1000 or less. The dielectric layers 140 may be made of a dielectric ceramic material including, for example, one of BaTiO₃, CaTiO₃, SrTiO₃, and CaZrO₃. Components less than the main component may be added to the dielectric layers 140. The components to be added may be, for example, Mn compounds, Fe compounds, Cr compounds, Co compounds, or Ni compounds. The thickness of each of the dielectric layers may be 0.5 μm or more and 30 μm or less.

The first inner electrode layer 151 and the second inner electrode layer 152 each contain Ni as a main component. The first inner electrode layer 151 and the second inner electrode layer 152 may further contain a dielectric material of the same composition system as the ceramic contained in the dielectric layer 140. In addition, the first inner electrode layer 151 and the second inner electrode layer 152 may contain Sn or the like at the interface with the dielectric layer 140.

As illustrated in FIG. 3, the multilayer body 101 is divided into an inner layer portion C, a first outer layer portion X1, a second outer layer portion X2, a first end margin portion E1, and a second end margin portion E2. The inner layer portion C has an electrostatic capacity because portions of the first inner electrode layers 151 and portions of the second inner electrode layers 152 are laminated together in the thickness direction T.

The first outer layer portion X1 and the second outer layer portion X2 sandwich the inner layer portion C in the thickness direction T. The first outer layer portion X1 is located outside the inner layer portion C in the thickness direction T and is located closer to the first main surface 111. The second outer layer portion X2 is located outside the inner layer portion C in the thickness direction T and is located closer to the second main surface 112.

The first outer layer portion X1 and the second outer layer portion X2 constitute the outer dielectric layers. The first outer layer portion X1 and the second outer layer portion X2 may be made of the same dielectric ceramic material as the plurality of dielectric layers 140 or may be made of a different dielectric ceramic material from the plurality of dielectric layers 140.

The thickness of the first outer layer portion X1 and the thickness of the second outer layer portion X2 may be 10 μm or more and 300 μm or less.

The first end margin portion E1 and the second end margin portion E2 sandwich the inner layer portion C in the length direction L. The first end margin portion E1 is located outside the inner layer portion C in the length direction L and is located closer to the first end face 115. The second end margin portion E2 is located outside the inner layer portion C in the length direction L and is located closer to the second end face 116.

In the body portion 110, the side margin portions are located between the first side surface 113 and the plurality of inner electrode layers 150 and between the second side surface 114 and the plurality of inner electrode layers 150 in the width direction W. The side margin portions include the first side margin portion S1 and the second side margin portion S2.

The first side margin portion S1 is provided to entirely cover one side surface of the multilayer body 101. The first side margin portion S1 is present from one end of the inner electrode layer 150 located on one side in the width direction W to the first side surface 113 in the body portion 110.

The second side margin portion S2 is provided to entirely cover the other side surface of the multilayer body 101. The second side margin portion S2 is present from the other end of the inner electrode layer 150 located on the other side in the width direction W to the second side surface 114 in the body portion 110.

The first side margin portion S1 and the second side margin portion S2 may be made of the same dielectric ceramic material as the plurality of dielectric layers 140 or may be made of a different dielectric ceramic material from the plurality of dielectric layers 140.

The first side margin portion S1 and the second side margin portion S2 may include a plurality of layers. An interface does not need to be observed between the plurality of layers.

As described above, the size of the multilayer ceramic capacitor 100 that includes the body portion 110, the first outer electrode 120, and the second outer electrode 130 is not particularly limited but can have, for example, the following range.

As illustrated in FIG. 3, the dimension (length dimension L0) in the length direction L of the multilayer ceramic capacitor 100 is, for example, 0.1 mm or more and 1.0 mm or less. The dimension in the thickness direction T (thickness dimension T0) of the multilayer ceramic capacitor 100 is, for example, 0.05 mm or more and 0.5 mm or less. As illustrated in FIG. 4, the dimension (width dimension W0) in the width direction of the multilayer ceramic capacitor 100 is, for example, 0.05 mm or more and 0.5 mm or less. It should be noted that the dimensions indicated here are values excluding the dimension tolerances. In practice, the dimension tolerances are added to the dimensions indicated here.

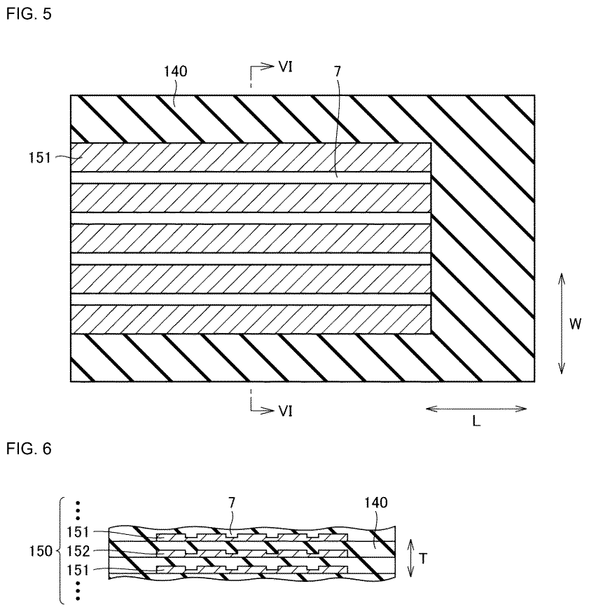

A plan view illustrating the state in which the inner electrode layers 150 included in the multilayer ceramic capacitor 100 and the dielectric layers 140 overlap each other is illustrated in FIG. 5 to indicate the position of the inner electrode layers 150 with respect to the dielectric layers 140. Here, the first inner electrode layers 151 are illustrated as an example of the inner electrode layers 150. In the case of the second inner electrode layers 152, the overlap with the dielectric layer 140 is reversed left and right as compared with the overlap illustrated in FIG. 5. The grooves in the surface of the plurality of inner electrode layers 150 are not illustrated in FIGS. 3 and 4, but a plurality of grooves 7 are actually provided in the surface of the inner electrode layer 150 as illustrated in FIG. 5. The plurality of grooves 7 are provided in parallel to each other. In the example illustrated here, the plurality of grooves 7 extend in the length direction L. A cross-sectional view as viewed along arrows VI-VI in FIG. 5 is illustrated in FIG. 6. FIG. 6 illustrates only a portion of the multilayer body 101.

The multilayer ceramic capacitor 100 includes a multilayer body 101. The multilayer body 101 includes the plurality of dielectric layers 140 and the plurality of inner electrode layers 150 that are laminated together. The multilayer body 101 has the first main surface 111 and the second main surface 112 that face away from each other in the lamination direction, the first side surface 113 and the second side surface 114 that face away from each other in the width direction W orthogonal to the lamination direction, and the first end face 115 and the second end face 116 that face away from each other in the length direction L orthogonal to the lamination direction and the width direction W. Outer electrodes electrically connected to at least one of the plurality of inner electrode layers 150 are disposed so as to cover at least a portion of the first end face 115 and at least a portion of the second end face 116. The outer electrodes here are the first outer electrode 120 and the second outer electrode 130. At least portions of the plurality of inner electrode layers 150 have the plurality of grooves 7, and at least portions of the plurality of dielectric layers 140 fit into, i.e., extend into, the plurality of grooves 7. In the context of the present disclosure, the contact boundary between the inner electrode layers 150 and the dielectric layers 140 forms an uneven interface. The grooves 7 may be referred to herein as recessed portions defined in a first layer (e.g., the inner electrode layer). Consequently, the portions of the adjacent second layer (e.g., the dielectric layer) that fill or extend into these grooves 7 may be referred to as protruding portions.

### Operation and Effects

In the embodiment, at least portions of the plurality of inner electrode layers 150 have the plurality of grooves 7, and at least portions of the plurality of dielectric layers 140 fit into the plurality of grooves 7, and accordingly, the joint between the dielectric layers 140 and the inner electrode layers 150 becomes strong. This can suppress the occurrence of possible delamination between the inner electrode layers and the dielectric layers in the multilayer body during sintering. Accordingly, the joint between the dielectric layers 140 and the inner electrode layers 150 may be strengthened. This can suppress the occurrence of possible delamination between the inner electrode layers and the dielectric layers in the multilayer body during sintering.

As illustrated in the embodiment, the plurality of grooves 7 may extend in the length direction L.

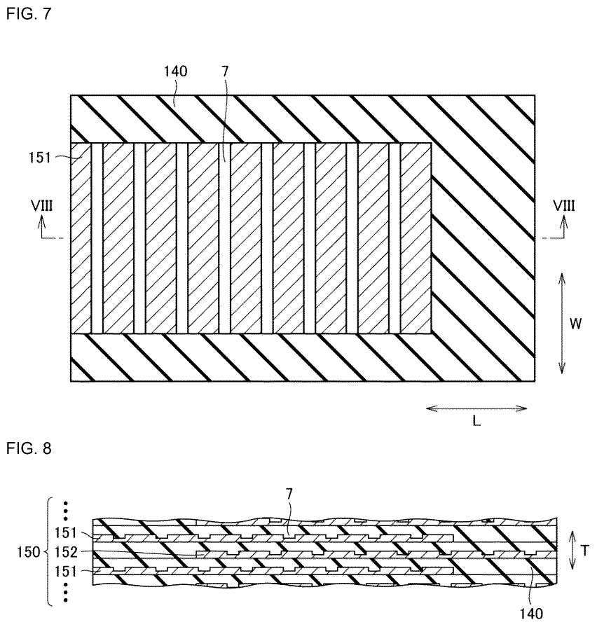

Alternatively, as illustrated in FIGS. 7 and 8, the plurality of grooves 7 may extend in the width direction W. FIG. 8 is a cross-sectional view as viewed along arrows VIII-VIII in FIG. 7. FIG. 8 illustrates only a portion of the multilayer body 101.

The widths of the plurality of grooves 7 may be 5 μm or more and 100 μm or less. The depths of the plurality of grooves 7 may be preferably 0.5 μm or more and 30 μm or less. When the depths of the grooves 7 are less than 0.5 μm, the effect of suppressing delamination cannot be sufficiently obtained. When the depths of the grooves 7 are more than 30 μm, the dielectric layers do not sufficiently fit into the grooves 7. Accordingly, the depths of the plurality of grooves 7 may be 0.5 μm or more and 30 μm or less.

The thicknesses of the plurality of dielectric layers 140 may be 0.5 μm or more and 30 μm or less.

The thicknesses the plurality of inner electrode layers 150 may be 0.5 μm or more and 3 μm or less.

The number of grooves 7 formed in one inner electrode layer 150 may be 5 or more and 1000 or less. This is because the effect of suppressing delamination cannot be sufficiently obtained when the number of grooves is less than five.

### Method of Manufacturing Multilayer Ceramic Capacitor

It should be noted that the following manufacturing method can be adopted to obtain the multilayer ceramic capacitor.

First, dielectric sheets on which the dielectric layers 140 are based are prepared. The dielectric sheets are, for example, ceramic green sheets. In addition, a conductive paste for forming the inner electrode layers 150 is prepared. The dielectric sheets and the conductive paste used here contain binders and solvents. Known binders and organic solvents can be used as the binders and the solvents.

Next, the conductive paste is applied onto the surface of each of the dielectric sheets in a predetermined pattern by using a known technique, such as screen printing or gravure printing. A pattern of the inner electrode layers is formed in this way. At this time, grooves 7 are formed in the surface of the pattern of the inner electrode layers. The method of forming the grooves 7 in the inner electrode layers will be described later.

A predetermined number of dielectric sheets on which no inner electrode layers are printed are laminated. This portion becomes the second outer layer portion X2. A predetermined number of dielectric sheets on which a pattern of the inner electrode layers has been printed are laminated on this multilayer body. This portion partially becomes the inner layer portion C. In addition, a predetermined number of dielectric sheets on which no inner electrode layers are printed are laminated thereon. This portion becomes the first outer layer portion X1. The multilayer body obtained in this way is pressed in the lamination direction by a treatment, such as hydrostatic pressing. Since the dielectric layers 140 can deform during this pressing, the dielectric layers 140 fit into the grooves 7 formed in the pattern of the inner electrode layers. A multilayer body block is obtained in this way. Multilayer body chips are obtained by the multilayer body block being cut into a predetermined size. In addition, barrel grinding or the like may be performed to round the corner portions and the ridge portions of the multilayer body chips. The multilayer body chips are fired to obtain the multilayer body 101. The firing temperature is selected in accordance with the type of material of the dielectric layers and the inner electrode layers. The firing temperature may be 900° C. or more and 1300° C. or less. The conductive paste for forming the outer electrodes is applied to both end faces of the multilayer body 101 and is baked. The baked layers of the outer electrodes are formed. The baking temperature may be 700° C. or more and 900° C. or less. The surfaces of the baked layers are plated as necessary. The first outer electrode 120 and the second outer electrode 130 are formed in this way.

### Method of Forming Grooves

The method of forming the grooves 7 in the inner electrode layers will be described. When the conductive paste is applied onto the surfaces of the ceramic green sheets that become the dielectric layers 140 to form the inner electrode layers 150, the following method can be adopted to form the grooves 7. First, the conductive paste is applied onto the surfaces of the ceramic green sheets. A mold with slits is pressed against the conductive paste before the conductive paste dries. The conductive paste is not pressed and remains thick in the regions corresponding to the slits, but the conductive paste is pressed and becomes thin in the regions not corresponding to the slits, and accordingly, grooves are formed in the regions. In this mold, the width of the regions not corresponding to the slits may be set to approximately 90% of a desired width of the grooves. This setting can obtain the grooves with the desired width as a result.

Alternatively, when screen printing is performed to apply the conductive paste onto the surfaces of the ceramic green sheets that become the dielectric layers to form the inner electrode layers, the regions corresponding to the grooves of the mesh of screen printing can be masked. As a result, the thickness of the conductive paste in the regions corresponding to the grooves is smaller than that in other regions, the desired grooves can be achieved.

Alternatively, the conductive paste may be applied by an inkjet head to form the inner electrode layers. In this case, the desired grooves can be formed by adjusting the spacing of the nozzles of the inkjet head.

### Reverse Structure

The scenario in which grooves are provided in the inner electrode layers 150 and the dielectric layers 140 fit into the grooves has been described above. Conversely, however, the grooves may be provided in the dielectric layers 140, and the inner electrode layers 150 may fit into the grooves. Thus, the multilayer ceramic capacitor generally includes a first layer selected from the plurality of dielectric layers and the plurality of inner electrode layers, and a second layer selected from the other of the plurality of dielectric layers and the plurality of inner electrode layers. The uneven interface is formed regardless of which specific material layer contains the recessed portions (grooves) and which contains the protruding portions. In this case, the grooves only need to be formed in the surfaces of the dielectric layers 140 in advance by using known techniques. By applying the conductive paste onto the surfaces of the dielectric layers 140 in which the grooves have been formed in this way, the structure in which the inner electrode layers 150 fit into the grooves of the dielectric layers 140 can be obtained.

### Method of Determining Thickness

It should be noted that the thicknesses of the inner electrode layers and the dielectric layers refer to the average thicknesses. The average thicknesses are measured as described below. First, the cross section of the multilayer body orthogonal to the length direction L having been exposed by grinding is observed by a scanning electron microscope. Next, the thicknesses on a total of five lines are measured. The five lines include the centerline, in the lamination direction, that passes through the center of the cross section of the multilayer body, two lines drawn at equal intervals on one side of the centerline, and two lines drawn at equal intervals on the other side of the centerline. The average value of these five measurement values is referred to as the average thickness. When a more accurate average thickness is obtained, the five measurement values described above are obtained for the upper portion, the middle portion, and the lower portion in the lamination direction, and the average value of these measurement values are determined as the average thickness.

It should be noted that two or more of the embodiments described above may be combined with each other. It should be noted that the embodiments disclosed here are illustrative in all respects and are not restrictive. The scope of the present invention is defined by the claims and includes all modifications within the meaning and the scope equivalent to the claims.

What is claimed is:

1. A multilayer ceramic capacitor comprising:
a multilayer body including a plurality of dielectric layers and a plurality of inner electrode layers that are laminated together along a lamination direction; and
an outer electrode electrically connected to at least one of the plurality of inner electrode layers; wherein
the multilayer body includes an uneven interface between a first layer selected from the plurality of dielectric layers and a second layer selected from the plurality of inner electrode layers,
the uneven interface includes a plurality of recessed portions defined in the first layer, and
the second layer includes a plurality of protruding portions extending into the plurality of recessed portions.

2. The multilayer ceramic capacitor according to claim 1,
wherein the first layer is one of the plurality of inner electrode layers, and the second layer is one of the plurality of dielectric layers.

3. The multilayer ceramic capacitor according to claim 1, wherein the first layer is one of the plurality of dielectric layers, and the second layer is one of the plurality of inner electrode layers.

4. The multilayer ceramic capacitor according to claim 1,
wherein the plurality of recessed portions extend in a width direction orthogonal to the lamination direction.

5. The multilayer ceramic capacitor according to claim 1,
wherein the plurality of recessed portions extend in a length direction orthogonal to the lamination direction.

6. The multilayer ceramic capacitor according to claim 1,
wherein the plurality of recessed portions each have a width between 5 μm and 100 μm, inclusive.

7. The multilayer ceramic capacitor according to claim 1,
wherein the plurality of recessed portions each have a depth between 0.5 μm and 30 μm, inclusive.

8. The multilayer ceramic capacitor according to claim 1,
wherein the plurality of dielectric layers each have a thickness between 0.5 μm and 30 μm, inclusive.

9. The multilayer ceramic capacitor according to claim 1,
wherein the plurality of inner electrode layers each have a thickness between 0.5 μm and 3 μm, inclusive.

10. The multilayer ceramic capacitor according to claim 1, wherein the outer electrode is disposed to cover at least a portion of a first end face and at least a portion of a second end face of the multilayer body.

11. The multilayer ceramic capacitor according to claim 1, wherein the multilayer body includes:
a first main surface and a second main surface that face away from each other in the lamination direction;
a first side surface and a second side surface that face away from each other in a width direction orthogonal to the lamination direction; and
a first end face and a second end face that face away from each other in a length direction orthogonal to the lamination direction and the width direction.

12. The multilayer ceramic capacitor according to claim 11, wherein the first layer is one of the plurality of inner electrode layers, and the second layer is one of the plurality of dielectric layers, and the recessed portion is a groove in the one of the plurality of inner electrode layers.

13. The multilayer ceramic capacitor according to claim 12,
wherein the plurality of grooves extend in the width direction.

14. The multilayer ceramic capacitor according to claim 12,
wherein the plurality of grooves extend in the length direction.

15. The multilayer ceramic capacitor according to claim 1, wherein a number of the recessed portions defined in the first layer is between 5 and 1000, inclusive.

16. The multilayer ceramic capacitor according to claim 1, further comprising a pair of side margin portions disposed on the first side surface and the second side surface of the multilayer body, respectively, so as to cover the plurality of inner electrode layers in the width direction.

17. The multilayer ceramic capacitor according to claim 1, wherein
the multilayer body includes outer dielectric layers sandwiching the plurality of inner electrode layers in the lamination direction, and
a thickness of each of the outer dielectric layers is between 10 μm and 300 μm, inclusive.

18. A method of manufacturing a multilayer ceramic capacitor, comprising:
forming a multilayer body including a plurality of dielectric layers and a plurality of inner electrode layers; and
forming an outer electrode electrically connected to at least one of the plurality of inner electrode layers;
wherein forming the multilayer body includes:
forming a plurality of recessed portions in a first layer selected from the plurality of dielectric layers and the plurality of inner electrode layers; and
laminating the first layer with a second layer selected from the other of the plurality of dielectric layers and the plurality of inner electrode layers such that the second layer extends into the plurality of recessed portions to form an uneven interface.

19. The method according to claim 18, wherein the first layer is the inner electrode layer, and wherein forming the plurality of recessed portions includes pressing a mold having slits against a conductive paste used to form the inner electrode layer.

20. The method according to claim 18, wherein the first layer is the inner electrode layer, and wherein forming the plurality of recessed portions includes screen printing a conductive paste using a screen having a masked region corresponding to the plurality of recessed portions.
